(19) United States
(12) Patent Application Publication
(10) Pub. No.: US 2006/0187182 A1
(43) Pub. Date: Aug. 24, 2006

(54) Apparatus and method for compensating regional nonuniformity of a display panel

(75) Inventors: Chia-Lei Yu, Taipei (TW); Chih-Hsiung Hsu, Taipei (TW); Ming-Chang Chuang, Taipei (TW)

Correspondence Address: BIRCH STEWART KOLASCH & BIRCH, PO BOX 747, FALLS CHURCH, VA, 22040-0747, US

(73) Assignee: Asmedia Technology Inc.

(21) Appl. No.: 11/355,101

(22) Filed: Feb. 16, 2006

(30) Foreign Application Priority Data
Feb. 18, 2005 (TW) 94104958

(51) Int. Cl. G09G 5/02; G09G 3/36

(52) U.S. Cl. 345/102; 345/604

(57) ABSTRACT

Several display regions are defined on a display panel, and each display region has its panel characteristic data. A pixel data is received and the determined display region of the pixel data is determined. The pixel data is calibrated according to the panel characteristic data of the determined display region, and then the calibrated pixel data is transmitted to the display panel.

### RELATED APPLICATIONS

The present application is based on, and claims priority from, Taiwan Application Ser. No. 94104958, filed Feb. 18, 2005, the disclosure of which is hereby incorporated by reference herein in its entirety.

### BACKGROUND

1. Field of Invention

The present invention relates to a flat panel display. More particularly, the present invention relates to an apparatus and method for compensating regional nonuniformity of a display panel.

2. Description of Related Art

Since the multimedia applications are highly developed, the users are getting more and more desire for the display and sound equipment. The conventional and general used cathode ray tube (CRT) display does not meet this desire because of the large volume of the equipment. Therefore, many flat panel displays, such as the liquid crystal display (LCD), the plasma display panel (PDP), and the field emission display (FED) have been recently developed. These displays are light-weighted and small in volume and thus have already become mainstream.

However, the processing of making current display cannot ensure that every pixel on the panel has the same characteristics. For a liquid crystal display, either liquid crystal filling or backlight design may cause some different positions on the same panel to have different characteristics, like different brightness or color characteristics. The different characteristics of the different positions on the same panel result in visual defects, viewed as nonuniformity of the panel.

### SUMMARY

It is therefore an aspect of the present invention to provide an apparatus and a method for compensating regional nonuniformity of a display panel. The apparatus and method provide different compensation for the different positions of the pixel data and, therefore, the users get the same visual feeling from every positions of the display.

According to one preferred embodiment of the present invention, the method defines a plurality of display regions on a display panel, and each of the display regions has a panel characteristic data. A pixel data is received, and to which of the display regions the pixel data corresponds is determined. The pixel data is calibrated according to the panel characteristic data of the determined display region. The display panel is adjusted according to the calibrated pixel data.

It is another aspect of the present invention to provide a method for compensating pixel data. The compensation of the method is based on the display region at which the pixel data is located, improving the spatial nonuniformity of the conventional display panel when displaying the same pixel data.

According to another preferred embodiment of the present invention, the method receives the pixel data and determines to which display region on a display panel the pixel data corresponds by a display region interpreter. The pixel data is calibrated by a panel characteristic corrector according to a panel characteristic data of the determined display region stored in a panel characteristic recorder. The display panel is adjusted according to the calibrated pixel data.

It is still another aspect of the present invention to provide an apparatus for compensating regional nonuniformity of a display panel, which compensates pixel data by software or hardware before displaying, for the display panel having different positions of different characteristics, thus avoiding regional nonuniformity.

According to another preferred embodiment of the present invention, the apparatus comprises a display region interpreter, a panel characteristic recorder and a panel characteristic corrector. The display region interpreter determines to which display region the pixel data corresponds, and the display panel has a plurality of display regions. The panel characteristic recorder contains panel characteristic data of the display regions. The panel characteristic recorder is electrically connected to the display region interpreter and selects the panel characteristic data of the determined display region. The panel characteristic corrector is electrically connected to the panel characteristic recorder and calibrates the pixel data according to the corresponding panel characteristic data.

It is to be understood that both the foregoing general description and the following detailed description are examples and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1 is a flow chart of one preferred embodiment of the present invention;

FIG. 2 is a flow chart of the defining of display regions in the preferred embodiment;

FIG. 3A is a schematic view of one preferred embodiment of the present invention; and

FIG. 3B is a functional block circuit diagram of one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides different levels of the compensation to the pixel data according to the different positions of the display panel to which the pixel data corresponds, so as to give users uniform visual feeling for every pixel.

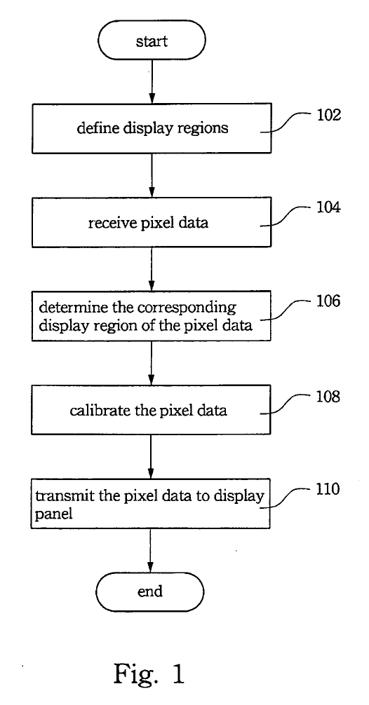

FIG. 1 is a flow chart of one preferred embodiment of the present invention. The step 102 is defining many display regions on a display panel, and each display region may have different panel characteristic data. The step 104 is receiving a pixel data, and the step 106 is determining to which display region the pixel data corresponds. The step 108 is calibrating the pixel data according to the panel characteristic data of the determined display region. And the step 110 is transmitting the calibrated pixel data to the display panel.

The display panel can be a display panel of a liquid crystal display, a plasma display panel or a field emission display. Moreover, for the display regions defined in step 102, a maximum of the quantity is equal to the quantity of pixels of the display panel, and a minimum of the quantity is equal to 2. In other words, a minimum size of the display region is equal to the size of a single pixel, and a maximum size of the display region is equal to a half of the size of the display panel.

In practical applications, the quantity of the display regions defined on the display panel should be defined in consideration of the available hardware and software abilities, the processing speed of the circuits or programs for calibrating the pixel data. The higher the quantity of display regions, the better the data processing ability must be for dealing with the total calibrations in a limited time. Moreover, when the defined quantity of the display regions is greater (i.e. the size of each display region is smaller), the compensation for regional nonuniformity is more obvious; when the defined quantity of the display regions is lower (i.e. the size of each display region is greater), the compensation for regional nonuniformity is less obvious. Persons skilled in the art can decide a suitable quantity of the display regions by weighing the data processing ability and the compensation effect.

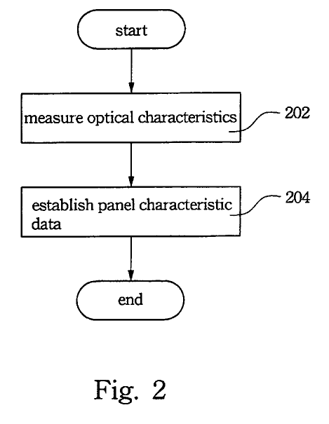

FIG. 2 is a flow chart of the defining of display regions in the preferred embodiment, further interpreting how the panel characteristic data of each display region is obtained. After deciding the quantity and the defining manner of the display regions, the step 202 is measuring the optical characteristics of each display region to obtain the panel characteristic data of each display region. And the step 204 is establishing the panel characteristic data of each of the display regions according to the optical characteristics of the display regions, and the panel characteristic data are used to unify the display results of an identical pixel data displayed in the display regions.

The preferred embodiment uses a calorimeter, a spectrum analyzer or other suitable optical characteristic measuring unit to measure the optical characteristics of the display regions. The optical characteristics include brightness, saturation and hue, for example. Furthermore, in order to prevent the pixel data of some display regions from being adjusted beyond a reasonable range, the panel characteristic data are established based on a maximum or a minimum of the optical characteristics of the display regions, or based on other suitable standards.

Taking the brightness compensation as an example, the original brightness of each display region is firstly recorded, such as the original brightnesses of different display regions as they display the same pixel data, and the brightness differences of different display regions are calculated. For a display region of higher brightness, the brightness difference of the display region is subtracted from the brightness of the corresponding pixel data; for a display region of lower brightness, the brightness difference of the display region is added to the brightness of the corresponding pixel data. Thus, brightness uniformity can be obtained on a display panel. Moreover, the added or subtracted brightness differences of display regions must be decided based on the maximum or the minimum of the optical characteristics of the display regions, or based on other suitable standards, in order to prevent the calibrated pixel data from exceeding their limitations and failing to achieve the correct compensation.

More precisely, by the preferred embodiment, the manufacture can establish one panel characteristic data for display panels of the same batch or even for each display panel, and compensate pixel data according to the panel characteristic data with the hardware (e.g., integrated circuits) or the software (e.g., drivers), thus improving the regional nonuniformity of the display panel. Alternatively, the manufacture can incorporate the embodiment into the hardware (e.g., integrated circuits) or the software (e.g., drivers) of the display panel, for users to establish the panel characteristic data and then calibrate the display result of the display panel by themselves whenever the display panel has a regional nonuniformity caused by, for example, high-temperature use or the fading of the backlight module because of long-term use.

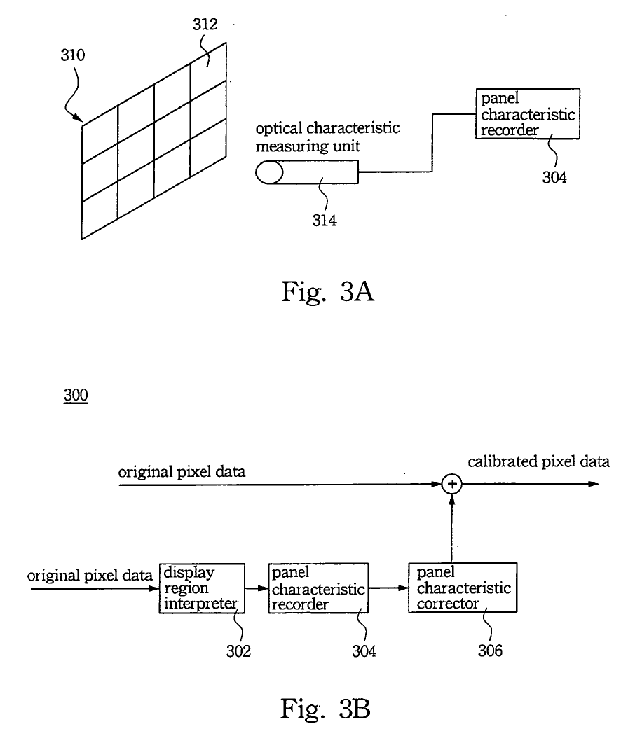

FIG. 3A is a schematic view of one preferred embodiment of the present invention illustrating the use of an optical characteristic measuring unit to measure the optical characteristics of the display regions. An optical characteristic measuring unit 314 measures the optical characteristics of each display region 312 of a display panel 310. The panel characteristic recorder 304 establishes and stores the panel characteristic data of each of the display regions 312 according to the optical characteristics of the display regions. The panel characteristic data unify display results of an identical pixel data displayed in the different display regions 312.

In the preferred embodiment, the display panel 310 is defined as 12 display regions 312. As mentioned above, the quantity of the display regions 312 can be decided according to the condition and requirement and is not limited by the preferred embodiment. The optical characteristic measuring unit 314 can be a colorimeter, a spectrum analyzer or other suitable optical characteristic measuring unit. The optical characteristics include brightness, saturation and hue, for example. Similarly, in order to prevent the pixel data of some display regions 312 from being adjusted beyond a reasonable range, the panel characteristic data are established based on a maximum or a minimum of the optical characteristics of the display regions, or based on other suitable standards.

FIG. 3B is a functional block circuit diagram of one preferred embodiment of the present invention. The following descriptions are made with reference to FIG. 3A and FIG. 3B. A compensation apparatus 300 has a display region interpreter 302, a panel characteristic recorder 304 and a panel characteristic corrector 306. The display region interpreter 302 determines to which of the display regions 312 of the display panel 310 the pixel data corresponds. The panel characteristic recorder 304 contains panel characteristic data of the display regions 314. The panel characteristic recorder 304 is electrically connected to the display region interpreter 302 and selects the panel characteristic data of the determined display region 312. The panel characteristic corrector 306 is electrically connected to the panel characteristic recorder 304 and calibrates the pixel data according to the corresponding panel characteristic data.

Generally, the display region interpreter 302, the panel characteristic recorder 304 and the panel characteristic corrector 306 can be circuits, firmware, software or their combinations. For example, the three elements 302, 304 and 306 can be integrated into an IC chip of the display, such that users can obtain the compensated display results of the compensation apparatus 300 from the display without additional actions. Alternatively, the three elements 302, 304 and 306 can be integrated into a driver of a display card, such that users can upgrade or set up the compensation content of the driver, thus enhancing the flexibility and efficiency of the compensation apparatus 300. Further, persons skilled in the art should understand that, the foregoing three elements 302, 304 and 306 do not have to be simultaneously integrated into a single hardware or single software and can be adequately separated or improved into different hardware and software according to design and requirements, so as to optimize both the data processing ability and compensation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for compensating regional nonuniformity of a display panel, the method comprising:
defining a plurality of display regions on the display panel, wherein each display region has panel characteristic data;
receiving a pixel data;
determining to which display region the pixel data corresponds for a determined display region;
calibrating the pixel data according to the panel characteristic data of the determined display region for a calibrated pixel data; and
correcting the display panel with the calibrated pixel data.

2. The method of claim 1, further comprising:
measuring optical characteristics of each of the display regions; and
establishing the panel characteristic data of each of the display regions according to the optical characteristics of the display regions, wherein the panel characteristic data unify display results of an identical pixel data displayed in the display regions.

3. The method of claim 2, wherein the optical characteristics of the display regions are measured with a colorimeter or a spectrum analyzer.

4. The method of claim 2, wherein the optical characteristics comprise brightness, saturation and hue.

5. The method of claim 2, wherein the panel characteristic data are established based on a maximum or a minimum of the optical characteristics of the display regions.

6. The method of claim 1, wherein a maximum quantity of the display regions is equal to a quantity of pixels of the display panel, and a minimum quantity of the display regions is equal to 2.

7. A method for compensating a pixel data, the method comprising:
receiving the pixel data and determining to which display region on a display panel the pixel data corresponds by a display region interpreter;
calibrating the pixel data by a panel characteristic corrector according to a panel characteristic data of the determined display region stored in a panel characteristic recorder; and
adjusting the display panel according to the calibrated pixel data.

8. The method of claim 7, further comprising:
defining a plurality of display regions on the display panel; and
establishing panel characteristic data of each of the display regions.

9. The method of claim 8, further comprising:
measuring optical characteristics of each of the display regions by an optical characteristic measuring unit; and
establishing the panel characteristic data of each of the display regions according to the optical characteristics of the display regions, and storing the panel characteristic data of the display regions in the panel characteristic recorder, wherein the panel characteristic data unify display results of an identical pixel data displayed in the display regions.

10. The method of claim 9, wherein the optical characteristics comprise brightness, saturation and hue.

11. The method of claim 9, wherein the panel characteristic data are established based on a maximum or a minimum of the optical characteristics of the display regions.

12. The method of claim 7, wherein a maximum quantity of the display regions is equal to a quantity of pixels of the display panel, and a minimum quantity of the display regions is equal to 2.

13. An apparatus for compensating regional nonuniformity of a display panel, the apparatus comprising:
a display region interpreter arranged to determine to which display region a pixel data corresponds, wherein the display panel has a plurality of display regions;
a panel characteristic recorder having panel characteristic data of the display regions, the panel characteristic recorder electrically connected to the display region interpreter and arranged to select the panel characteristic data of the determined display region; and
a panel characteristic corrector electrically connected to the panel characteristic recorder and arranged to calibrate the pixel data according to the corresponding panel characteristic data.

14. The apparatus of claim 13, wherein the panel characteristic corrector is arranged to generate a calibrating data according to the corresponding panel characteristic data and to calibrate the pixel data with the calibrating data.

15. The apparatus of claim 13, wherein a maximum quantity of the display regions is equal to a quantity of pixels of the display panel, and a minimum quantity of the display regions is equal to 2.

16. The apparatus of claim 13, further comprising:
an optical characteristic measuring unit arranged to measure optical characteristics of each of the display regions, wherein the panel characteristic data are established according to the optical characteristics of the display regions, and the panel characteristic data unify display results of an identical pixel data displayed in the display regions.

17. The apparatus of claim 16, wherein the optical characteristic measuring unit is a calorimeter or a spectrum analyzer.

18. The apparatus of claim 16, wherein the optical characteristics comprise brightness, saturation and hue.

19. The apparatus of claim 16, wherein the panel characteristic data are established based on a maximum or a minimum of the optical characteristics of the display regions.

20. The apparatus of claim 13, wherein the display region interpreter, the panel characteristic recorder and the panel characteristic corrector are integrated in an integrated circuit chip.
